(19) United States
(12) Patent Application Publication
(10) Pub. No.: US 2018/0229338 A1
(43) Pub. Date: Aug. 16, 2018

(54) ANGLE HEAD ATTACHMENT OF A MACHINE TOOL

(71) Applicant: DOOSAN MACHINE TOOLS CO., LTD., Chang-won-si (KR)

(72) Inventor: Young-Kun JUNG, Chang-won-si, (KR)

(21) Appl. No.: 15/882,401

(22) Filed: Jan. 29, 2018

(30) Foreign Application Priority Data
Feb. 14, 2017 (KR) 10-2017-0019764

(51) Int. Cl. B23Q 5/04

(52) U.S. Cl. CPC B23Q 5/045; B23Q 2701/02

(57) ABSTRACT

An angle head attachment of a machine tool may include a main shaft, a bevel gear, a spindle and at least one idle gear module. The main shaft may be rotated with respect to a first direction. The bevel gear may be configured to convert a rotary force of the main shaft into a rotary force rotated with respect to a second direction substantially perpendicular to the first direction. The spindle may be rotated with respect to the second direction by the rotary force of the bevel gear. The idle gear module may be interposed between the bevel gear and the spindle to transmit the rotary force of the bevel gear to the spindle. The rotary force of the main shaft may be transmitted to the spindle through the at least one idle gear module so that the angle head attachment may have a slim structure.

### CROSS-RELATED APPLICATION

This application claims priority under 35 USC § 119 to Korean Patent Application No. 2017-0019764, filed on Feb. 14, 2017 in the Korean Intellectual Property Office (KIPO), the contents of which are herein incorporated by reference in their entirety.

### BACKGROUND

### 1. Field

Example embodiments relate to an angle head attachment of a machine tool. More particularly, example embodiments relate to an angle head attachment of a machine tool configured to hold an angle head for processing a side surface of a workpiece.

### 2. Description of the Related Art

Generally, a large machine tool may be configured to process a workpiece using a plurality of tools. The tools may be mounted at the large machine tool using an attachment.

According to related arts, when a side surface of a workpiece such as an engine block having a narrow width and a long length may be processed using an angle head, an angle head attachment may interference with the workpiece. Thus, in order to process the workpiece, the workpiece may be transferred to another machine tool.

### SUMMARY

Example embodiments provide an angle head attachment that may be capable of preventing an interference of a workpiece.

According to example embodiments, there may be provided an angle head attachment of a machine tool. The angle head attachment may include a main shaft, a bevel gear, a spindle and at least one idle gear module. The main shaft may be rotated with respect to a first direction. The bevel gear may be configured to convert a rotary force of the main shaft into a rotary force rotated with respect to a second direction substantially perpendicular to the first direction. The spindle may be rotated with respect to the second direction by the rotary force of the bevel gear. The idle gear module may be interposed between the bevel gear and the spindle to transmit the rotary force of the bevel gear to the spindle.

In example embodiments, the idle gear module may have a width substantially the same as that of the spindle.

In example embodiments, the idle gear module may include an idle shaft arranged in the second direction, and an idle gear rotatably combined with an outer surface of the idle shaft. The idle gear may be engaged with the bevel gear. The idle gear may be combined with the spindle.

In example embodiments, the idle gear may be positioned on the first direction.

In example embodiments, the idle gear module may further include a housing configured to receive the idle shaft.

In example embodiments, the housing may have a receiving groove into which an end of the idle shaft may be movably inserted.

In example embodiments, a gap may be formed between the receiving groove and the end of the idle shaft. At least one fixing bolt may be threaded with the end of the idle shaft from the housing through the gap.

In example embodiments, the idle shaft may be drawn to the housing in a narrowing direction of the gap by tightening the fixing bolt so that the housing may pre-load the idle gear.

In example embodiments, the idle gear module may further include a collar installed on an outer surface of the idle shaft between the idle gear and the housing.

In example embodiments, the idle gear module may include a plurality of modules detachably combined with each other.

In example embodiments, the idle gear modules may have substantially the same size.

According to example embodiments, there may be provided an angle head attachment of a machine tool. The angle head attachment may include a main shaft, a bevel gear, a spindle and a plurality of idle gear modules. The main shaft may be rotated with respect to a first direction. The bevel gear may be configured to convert a rotary force of the main shaft into a rotary force rotated with respect to a second direction substantially perpendicular to the first direction. The spindle may be rotated with respect to the second direction by the rotary force of the bevel gear. An angle head may be installed at the spindle. The idle gear modules may be interposed between the bevel gear and the spindle to transmit the rotary force of the bevel gear to the spindle. The idle gear modules may have a width substantially the same as that of the spindle. Each of the idle gear modules may include an idle gear having a rotation center on the first direction.

In example embodiments, each of the idle gear modules may include an idle shaft, the idle gear, a housing and a collar. The idle shaft may be arranged in the second direction. The idle gear may be rotatably combined with an outer surface of the idle shaft. The idle gear may be engaged with the bevel gear. The idle gear may be combined with the spindle. The idle shaft and the idle gear may be rotatably received along the second direction in the housing. The collar may be installed on an outer surface of the idle shaft between the idle gear and the housing.

In example embodiments, the housing may have a receiving groove into which an end of the idle shaft may be movably inserted.

In example embodiments, a gap may be formed between the receiving groove and the end of the idle shaft. At least one fixing bolt may be threaded with the end of the idle shaft from the housing through the gap.

According to example embodiments, there may be provided an angle head attachment of a machine tool. The angle head attachment may include a main shaft, a bevel gear, a spindle, a first idle gear module, at least one second idle gear module and a third idle gear module. The main shaft may be rotated with respect to a first direction. The bevel gear may be configured to convert a rotary force of the main shaft into a rotary force rotated with respect to a second direction substantially perpendicular to the first direction. The spindle may be rotated with respect to the second direction by the rotary force of the bevel gear. An angle head may be installed at the spindle. The first idle gear module may include a first idle gear engaged with the bevel gear. The second idle gear module may include a second idle gear engaged with the first idle gear. The third idle gear module may include a third idle gear engaged with the second idle gear. The third idle gear may be combined with the spindle.

In example embodiments, the second idle gear module may be detachably combined with the first and third idle gear modules.

In example embodiments, the second and third idle gear modules may have substantially the same size.

According to example embodiments, the rotary force of the main shaft may be transmitted to the spindle through the at least one idle gear module so that the angle head attachment may have a slim structure. Thus, the angle head attachment may not interfere with a workpiece having a narrow width and a long length. Further, a length of the angle head attachment may be changed in accordance with the length of the workpiece by adjusting numbers of the idle gear modules.

### BRIEF DESCRIPTION OF THE DRAWINGS

Example embodiments will be more clearly understood from the following detailed description taken in conjunction with the accompanying drawings. FIGS. 1 to 4 represent non-limiting, example embodiments as described herein.

FIG. 1 is a perspective view illustrating a front face of an angle head attachment of a machine tool in accordance with example embodiments;

FIG. 2 is a perspective view illustrating a rear face of the angle head attachment in FIG. 1;

FIG. 3 is a cross-sectional view illustrating the angle head attachment in FIG. 1; and

FIG. 4 is an enlarged cross-sectional view illustrating an idle gear module of the angle head attachment in FIG. 3.

### DETAILED DESCRIPTION OF THE EMBODIMENTS

Various example embodiments will be described more fully hereinafter with reference to the accompanying drawings, in which some example embodiments are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

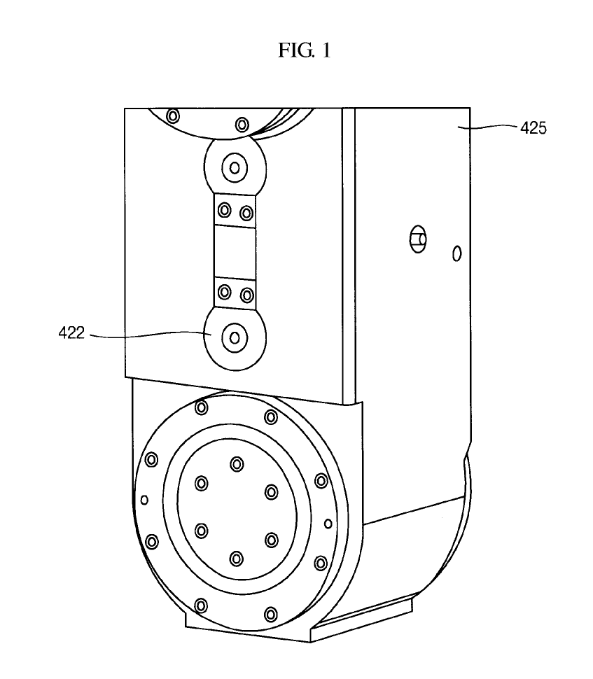

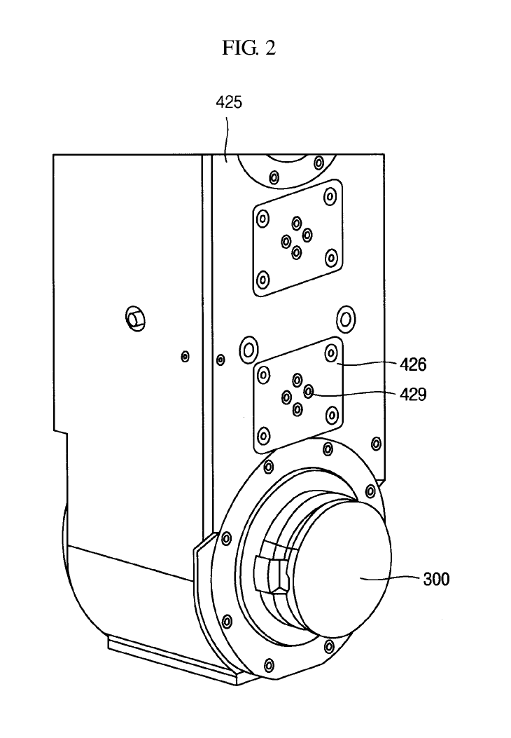

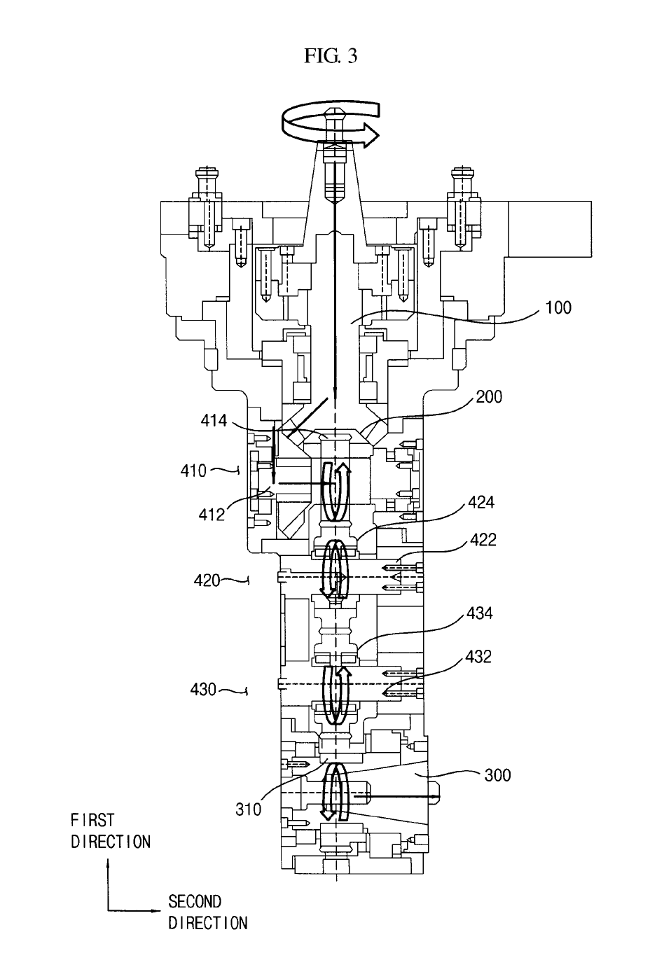

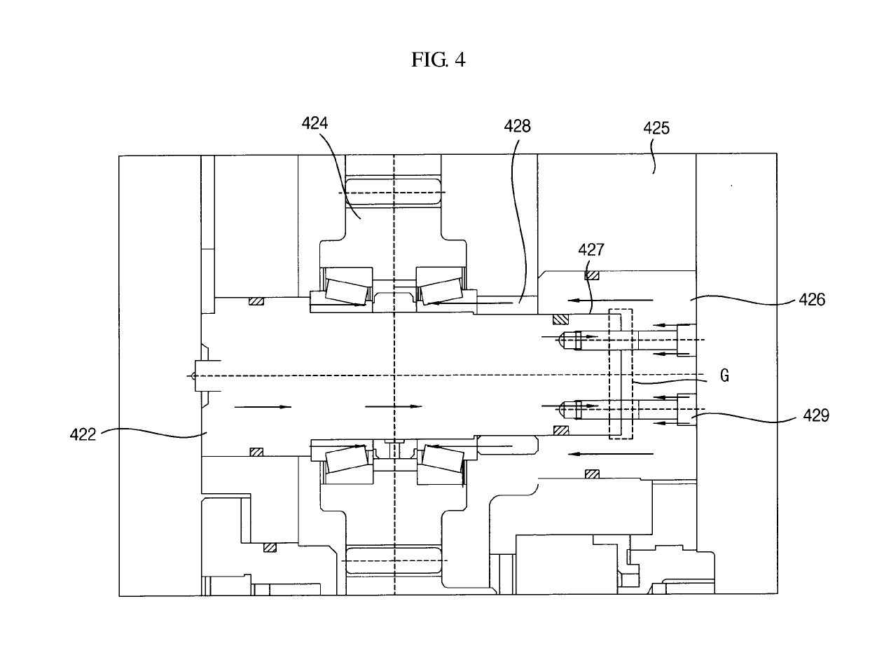

FIG. 1 is a perspective view illustrating a front face of an angle head attachment of a machine tool in accordance with example embodiments, FIG. 2 is a perspective view illustrating a rear face of the angle head attachment in FIG. 1, FIG. 3 is a cross-sectional view illustrating the angle head attachment in FIG. 1, and FIG. 4 is an enlarged cross-sectional view illustrating an idle gear module of the angle head attachment in FIG. 3.

Referring to FIGS. 1 to 3, an angle head attachment of a machine tool in accordance with example embodiments may include a main shaft 100, a bevel gear 200, first to third idle gear modules 410, 420 and 430, and a spindle 300.

In example embodiments, the angle head attachment may be used for processing a side surface of a workpiece such as an engine block having a narrow width and a long length. However, the angle head attachment may be used for processing other workpiece as well as the engine block.

The main shaft 100 may be rotated with respect to a first direction. Here, the first direction may correspond to a vertical direction. Thus, the main shaft 100 may generate a first rotary force rotated with respect to the first direction. That is, the main shaft 100 may have a center axis substantially parallel to the first direction.

The bevel gear 200 may be combined with a lower end of the main shaft 100. The bevel gear 200 may convert the first rotary force of the main shaft 100 into a second rotary force. The second rotary force may be rotated with respect to a second direction substantially perpendicular to the first direction. Because the first direction may be the vertical direction, the second direction may correspond to a horizontal direction.

The spindle 300 may be arranged under the bevel gear 200. An angle head configured to process the side surface of the workpiece may be mounted to the spindle 300. The spindle 300 may receive the second rotary force of the bevel gear 200. Thus, the spindle 300 may be rotated with respect to the second direction. The spindle 300 may have a center axis substantially parallel to the second direction.

The second rotary force of the bevel gear 200 may be transmitted to the spindle 300 through the first to third idle gear modules 410, 420 and 430. The first idle gear module 410 may be arranged under the bevel gear 200. The first idle gear module 410 may be combined with the bevel gear 200. The second idle gear module 420 may be arranged under the first idle gear module 410. The second idle gear module 420 may be combined with the first idle gear module 410. The third idle gear module 430 may be arranged under the second idle gear module 420. The third idle gear module 430 may be combined with the second idle gear module 420.

Particularly, the first idle gear module 410 may include a first idle shaft 412 and a first idle gear 414. The first idle shaft 412 may be arranged in the second direction. The first idle gear 414 may be rotatably combined with an outer surface of the first idle shaft 412. The first idle gear 414 may be engaged with the bevel gear 200. Thus, the first idle gear 414 may have a center axis substantially parallel to the second direction.

The second idle gear module 420 may include a second idle shaft 422 and a second idle gear 424. The second idle shaft 422 may be arranged in the second direction. Thus, the second idle shaft 422 may be substantially parallel to the first idle shaft 412. The second idle gear 424 may be rotatably combined with an outer surface of the second idle shaft 422. The second idle gear 424 may be engaged with the first idle gear 414. Thus, the second idle gear 424 may have a center axis substantially parallel to the second direction.

The third idle gear module 430 may include a third idle shaft 432 and a third idle gear 434. The third idle shaft 432 may be arranged in the second direction. Thus, the third idle shaft 432 may be substantially parallel to the first and second idle shafts 412 and 422. The third idle gear 434 may be rotatably combined with an outer surface of the third idle shaft 432. The third idle gear 434 may be engaged with the second idle gear 424. Thus, the third idle gear 434 may have a center axis substantially parallel to the second direction.

Further, the second idle gear 43 may be engaged with a spindle gear 310. Thus, the second rotary force of the bevel gear 200 may be transmitted to the spindle 300 through the first idle gear 414, the second idle gear 424, the third idle gear 434 and the spindle gear 310.

The first idle gear 412, the second idle gear 424, the third idle gear 434 and the spindle gear 410 may be positioned on the first direction. That is, the first idle gear 412, the second idle gear 424, the third idle gear 434 and the spindle gear 410 may be rotated with respect to center points on the axial direction of the main shaft 100. Because the rotation center of the spindle 300 may be located on the center axis of the main shaft 100, a protruded length of the spindle 300 from main shaft 100 in the second direction may be decreased.

The first to third idle gear modules 410, 420 and 430 may have substantially the same structure and size. The first to third idle gear modules 410, 420 and 430 may have a same first length along the first direction and a same second length along the second direction. Particularly, the second length of the first to third idle gear modules 410, 420 and 430 in the second direction, i.e., a width may be substantially the same as a width of the spindle 300. Therefore, the angle head attachment may have a slim structure suitable for processing the side surface of the workpiece having the narrow width and the long length.

Further, as mentioned above, because the first to third idle gear modules 410, 420 and 430 may have substantially the same size, numbers of the idle gear modules may be changed in accordance with a size of the workpiece. For example, the angle head attachment may include one, two or at least four idle gear modules. Removing of the idle gear module may be performed by a gear separation. Adding of the idle gear module may be performed by a gear combination.

Alternatively, the second and third idle gear modules 420 and 430 may have substantially the same structure and size. The first idle gear 410 may have a size different from that of the second and third idle gear modules 420 and 430. The second and third idle gear modules 420 and 430 may have a same first length along the first direction and a same second length along the second direction. Particularly, the second length of the second and third idle gear modules 420 and 430 in the second direction, i.e., a width may be substantially the same as a width of the spindle 300. Therefore, the angle head attachment may have a slim structure suitable for processing the side surface of the workpiece having the narrow width and the long length.

Further, the second idle gear module 420 may include a plurality of idle gear modules. The second idle gear modules 420 may have substantially the same size. Thus, numbers of the second idle gear modules 420 may be changed by the size of the workpiece.

Alternatively, the angle head attachment may include only the first and third idle gear modules 410 and 430. In this case, the first idle gear 412 of the first idle gear module 410 may be engaged with the third idle gear 434 of the third idle gear module 430.

Referring to FIG. 4, the second idle gear module 420 may include the second idle shaft 422, the second idle gear 424, a housing 426, a head body 425, a collar 428 and a plurality of fixing bolts 429.

As mentioned above, the second idle shaft 422 may be arranged in the second direction. The second idle gear 424 may be rotatably combined with the outer surface of the second idle shaft 422.

The second idle shaft 422 and the second idle gear 424 may be movably received in the housing 426. Particularly, the second idle shaft 422 and the second idle gear 424 may be movably received in the housing 426 along the second direction.

The housing 426 may have a receiving groove 427 configured to receive an end of the second idle shaft 422. A gap G may be formed between the end of the second idle shaft 422 and an inner surface of the receiving groove 427. The housing 426 may be fixed to the head body 425. The collar 428 may be arranged on the outer surface of the second idle shaft 422. The collar 428 may be positioned between the second idle gear 424 and the housing 426.

The fixing bolts 429 may be threaded with the end of the second idle shaft 422 from an outer surface of the housing 426 through the gap G in the second direction. When the fixing bolts 429 may be tightened, the second idle shaft 422 may be drawn toward the housing 426 so that the gap G may be narrowed. Because the housing 426 may be fixed to the head body 425, the housing 426 may pressurize the second idle gear 424 together with the collar 428 so that the second idle gear 424 may be pre-loaded.

In order to prevent the second idle shaft 422 and the housing 426 from being rotated during tightening the fixing bolts 429, the second idle shaft 422 and the housing 426 may have a chord shape and a quadrangle shape.

The first and third idle gear modules 410 and 430 may have a structure substantially the same as that of the second idle gear module 420. Thus, any further illustrations with respect to the structure of the first and third idle gear modules 410 and 430 may be omitted herein for brevity.

According to example embodiments, the rotary force of the main shaft may be transmitted to the spindle through the at least one idle gear module so that the angle head attachment may have a slim structure. Thus, the angle head attachment may not interfere with a workpiece having a narrow width and a long length. Further, a length of the angle head attachment may be changed in accordance with the length of the workpiece by adjusting numbers of the idle gear modules.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. An angle head attachment of a machine tool comprising:
a main shaft rotated with respect to a first direction;
a bevel gear configured to convert a rotary force of the main shaft into a rotary force rotated with respect to a second direction substantially perpendicular to the first direction;
a spindle rotated with respect to the second direction by the rotary force of the bevel gear, an angle head installed at the spindle; and
at least one idle gear module interposed between the bevel gear and the spindle to transmit the rotary force of the bevel gear to the spindle.

2. The angle head attachment of the machine tool of claim 1, wherein the idle gear module has a width substantially the same as a width of the spindle.

3. The angle head attachment of the machine tool of claim 1, wherein the idle gear module comprises:
an idle shaft arranged in the second direction; and
an idle gear rotatably combined with an outer surface of the idle shaft, the idle gear engaged with the bevel gear, and the idle gear combined with the spindle.

4. The angle head attachment of the machine tool of claim 3, wherein the idle gear is positioned on the first direction.

5. The angle head attachment of the machine tool of claim 3, wherein the idle gear module further comprises a housing configured to receive the idle shaft.

6. The angle head attachment of the machine tool of claim 5, wherein the housing comprises a receiving groove into which an end of the idle shaft is movably inserted.

7. The angle head attachment of the machine tool of claim 6, wherein a gap is formed between the receiving groove and the end of the idle shaft, and at least one fixing bolt is threaded with the end of the idle shaft from the housing through the gap.

8. The angle head attachment of the machine tool of claim 7, wherein the idle shaft is drawn toward the housing in a narrowing direction of the gap by tightening the fixing bolt to pre-load the idle gear by the housing.

9. The angle head attachment of the machine tool of claim 5, wherein the idle gear module further comprises a collar arranged on the outer surface of the idle shaft between the idle gear and the housing.

10. The angle head attachment of the machine tool of claim 1, wherein the idle gear module comprises a plurality of modules detachably combined with each other.

11. The angle head attachment of the machine tool of claim 10, wherein the idle gear modules have substantially the same size.

12. An angle head attachment of a machine tool comprising:
a main shaft rotated with respect to a first direction;
a bevel gear configured to convert a rotary force of the main shaft into a rotary force rotated with respect to a second direction substantially perpendicular to the first direction;
a spindle rotated with respect to the second direction by the rotary force of the bevel gear, an angle head installed at the spindle; and
a plurality of idle gear modules interposed between the bevel gear and the spindle to transmit the rotary force of the bevel gear to the spindle, the idle gear modules having a width substantially the same as a width of the spindle, and the idle gear modules having a rotation center on the first direction.

13. The angle head attachment of the machine tool of claim 12, wherein the idle gear module comprises:
an idle shaft arranged in the second direction;
an idle gear rotatably combined with an outer surface of the idle shaft, the idle gear engaged with the bevel gear, and the idle gear combined with the spindle;
a housing configured to movably receive the idle shaft and the idle gear; and
a collar arranged on the outer surface of the idle shaft between the idle gear and the housing.

14. The angle head attachment of the machine tool of claim 13, wherein the housing comprises a receiving groove into which an end of the idle shaft is movably inserted.

15. The angle head attachment of the machine tool of claim 14, wherein a gap is formed between the receiving groove and the end of the idle shaft, and at least one fixing bolt is threaded with the end of the idle shaft from the housing through the gap.

16. An angle head attachment of a machine tool comprising:
a main shaft rotated with respect to a first direction;
a bevel gear configured to convert a rotary force of the main shaft into a rotary force rotated with respect to a second direction substantially perpendicular to the first direction;
a spindle rotated with respect to the second direction by the rotary force of the bevel gear, an angle head installed at the spindle; and
a first idle gear module including a first idle gear engaged with the bevel gear;
at least one second idle gear module including a second idle gear engaged with the first idle gear; and
a third idle gear module including a third idle gear engaged with the second idle gear and combined with the spindle.

17. The angle head attachment of the machine tool of claim 16, wherein the second idle gear module is detachably combined with the first and third idle gear modules.

18. The angle head attachment of the machine tool of claim 16, wherein the second and third idle gear modules have substantially the same size.
